(19) United States
(12) Patent Application Publication
(10) Pub. No.: US 2016/0189682 A1
(43) Pub. Date: Jun. 30, 2016

(54) DISPLAY APPARATUS AND METHOD FOR CONTROLLING REFRESH FREQUENCY THEREOF

(71) Applicant: Novatek Microelectronics Corp., Hsinchu (TW)

(72) Inventor: Shang-I Liu, Kaohsiung City (TW)

(21) Appl. No.: 14/644,215

(22) Filed: Mar. 11, 2015

(30) Foreign Application Priority Data
Dec. 25, 2014 (TW) 103145464

(51) Int. Cl. G09G 5/18; G09G 5/10

(52) U.S. Cl. CPC G09G 5/18; G09G 5/10

(57) ABSTRACT

A display apparatus and a method for controlling a refresh frequency thereof are provided. The method includes: dividing a display image into a plurality of sub-display images; calculating a plurality of refresh frequency request values respectively corresponding to the sub-display images according to a plurality of patterns respectively corresponding to the sub-display images; and, calculating a refresh frequency of the display image according to the refresh frequency request values.

### CROSS-REFERENCE TO RELATED APPLICATION

This application claims the priority benefit of Taiwan application serial no. 103145464, filed on Dec. 25, 2014. The entirety of the above-mentioned patent application is hereby incorporated by reference herein and made a part of this specification.

### BACKGROUND

1. Technical Field

The invention relates to a display apparatus and a method for controlling a refresh frequency thereof, and particularly relates to a display apparatus capable of controlling a refresh frequency according to a display state of the display apparatus and a control method thereof.

2. Related Art

Along with development of electronic technology, consumer electronic products have become an indispensable part in people's daily life. In order to provide a good man-machine interface, it becomes a trend to configure a high-quality display apparatus to the consumer electronic product.

Today, liquid crystal display (LCD) apparatus is a popular display apparatus. The LCD apparatus executes a display operation by controlling a turn-over state of liquid crystal. Since the liquid crystal may have a polarization phenomenon when a constant bias is exerted to the liquid crystal for a long time, it is necessary to provide a regularly turned over bias voltage to the liquid crystal. Regarding the regular turn-over operation of the bias voltage, a frequency thereof cannot be too low since it should not be perceived by human eyes. Once the frequency of the frequency is too low, an image flickering phenomenon is occurred.

However, if a high-frequency liquid crystal turn-over operation is adopted to avoid occurrence of the flickering phenomenon, more power is consumed. Therefore, in the conventional technical field, a commercial power frequency (for example, 50 or 60 Hz) is generally adopted as a refresh frequency of a display image.

### SUMMARY

The invention is directed to a display apparatus and a method for controlling a refresh frequency thereof, by which the refresh frequency is dynamically adjusted according to a display state, so as to save a power consumption.

The invention provides a method for controlling a refresh frequency, which is adapted to a display apparatus, and the method includes following steps. A display image of the display apparatus is divided into a plurality of sub-display images. A plurality of refresh frequency request values respectively corresponding to the sub-display images are calculated according to a plurality of patterns respectively corresponding to the sub-display images. A refresh frequency of the display image is calculated according to the refresh frequency request values.

In an embodiment of the invention, the display image is a static display image.

In an embodiment of the invention, the patterns respectively have a plurality of gray levels.

In an embodiment of the invention, the step of respectively calculating the refresh frequency request values respectively corresponding to the sub-display images according to the patterns respectively corresponding to the sub-display images includes following steps. The gray levels respectively corresponding to the sub-display images are calculated, and the refresh frequency request values respectively corresponding to the sub-display images are obtained according to the gray levels. An arithmetic operation is performed to the refresh frequency request values to obtain the refresh frequency.

In an embodiment of the invention, the step of respectively calculating the refresh frequency request values respectively corresponding to the sub-display images according to the patterns respectively corresponding to the sub-display images includes following steps. The gray levels respectively corresponding to the sub-display images are calculated, and an arithmetic operation is performed to the gray levels to obtain a statistic gray level. Then, the refresh frequency is obtained according to the statistic gray level.

In an embodiment of the invention, the step of respectively calculating the refresh frequency request values respectively corresponding to the sub-display images according to the patterns respectively corresponding to the sub-display images includes following steps. A plurality of setting patterns are set, where the setting patterns respectively correspond to a plurality of refresh frequency setting values. Each of the patterns corresponding to each of the sub-display images is compared with the setting patterns to select one of the refresh frequency setting values as the refresh frequency request value corresponding to each of the sub-display images.

In an embodiment of the invention, the method further includes following steps. A plurality of weight values respectively corresponding to the sub-display images are determined according to regions where the sub-display images are located in the display image. Moreover, the refresh frequency is calculated according to the refresh frequency request values and the corresponding weight values.

In an embodiment of the invention, the step of dividing the display image of the display apparatus into a plurality of the sub-display images includes following steps: setting at least one dividing region; and dividing the display image into the sub-display image according to the dividing region.

In an embodiment of the invention, the sub-display images contact each other, and the adjacent sub-display images are not overlapped to each other or partially overlapped to each other.

In an embodiment of the invention, a shape of the dividing region is a rectangle, a round or an irregular shape, and sizes of the dividing regions are the same, partially same or totally different.

In an embodiment of the invention, the method for controlling the refresh frequency further includes following steps. A frequency adjustment value is obtained according to a backlight brightness of the display apparatus. And, the refresh frequency is reduced according to the frequency adjustment value to generate a reduced refresh frequency.

The invention provides a display apparatus including a display panel and a controller. The display panel generates a display image, and the controller is coupled to the display panel. The controller divides the display image into a plurality of sub-display images. The controller calculates a plurality of refresh frequency request values respectively corresponding to the sub-display images according to a plurality of patterns respectively corresponding to the sub-display images, and calculates a refresh frequency of the display image according to the refresh frequency request values.

According to the above descriptions, the display image is divided into a plurality of sub-display images, and the patterns of the sub-display images are analyzed to calculate a proper refresh frequency. Namely, the refresh frequency can be dynamically adjusted according to the display image, so as to achieve a purpose of saving power consumption.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flowchart illustrating a method for controlling a refresh frequency according to an embodiment of the invention.

FIG. 2A-FIG. 2C are schematic diagrams illustrating a plurality of implementations for dividing a plurality of sub-display images.

FIG. 3A is a diagram illustrating a relationship between gray levels and refresh frequency request values.

FIG. 3B is a schematic diagram of a plurality of setting patterns according to an embodiment of the invention.

FIG. 4A is a schematic diagram of a calculation method of a refresh frequency of a display image according to an embodiment of the invention.

FIG. 4B is a schematic diagram of a weight value distribution according to an embodiment of the invention.

FIG. 5 is a relationship diagram of refresh frequencies and backlight brightness according to an embodiment of the invention.

FIG. 6 is a schematic diagram of a display apparatus according to an embodiment of the invention.

### DETAILED DESCRIPTION OF DISCLOSED EMBODIMENTS

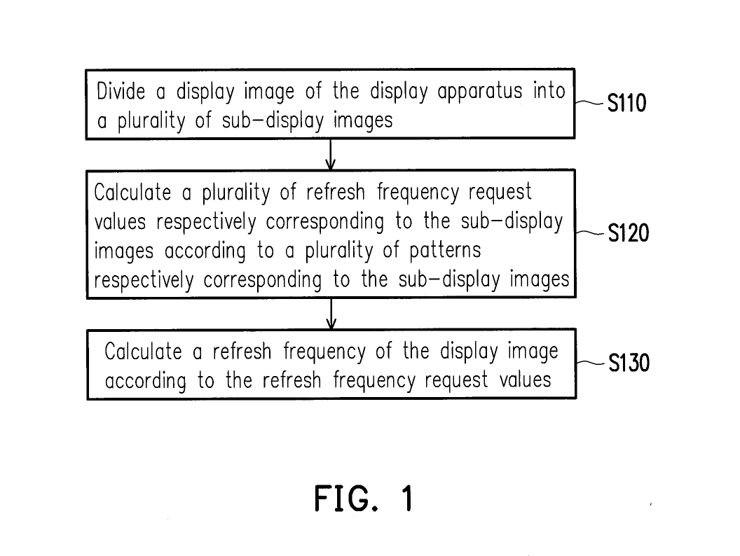

Referring to FIG. 1, FIG. 1 is a flowchart illustrating a method for controlling a refresh frequency according to an embodiment of the invention. In the present embodiment, a display image of a display apparatus is detected to implement setting a refresh frequency of the display image. In step S110, the display image of the display apparatus is divided into a plurality of sub-display images. The display image id s static display image.

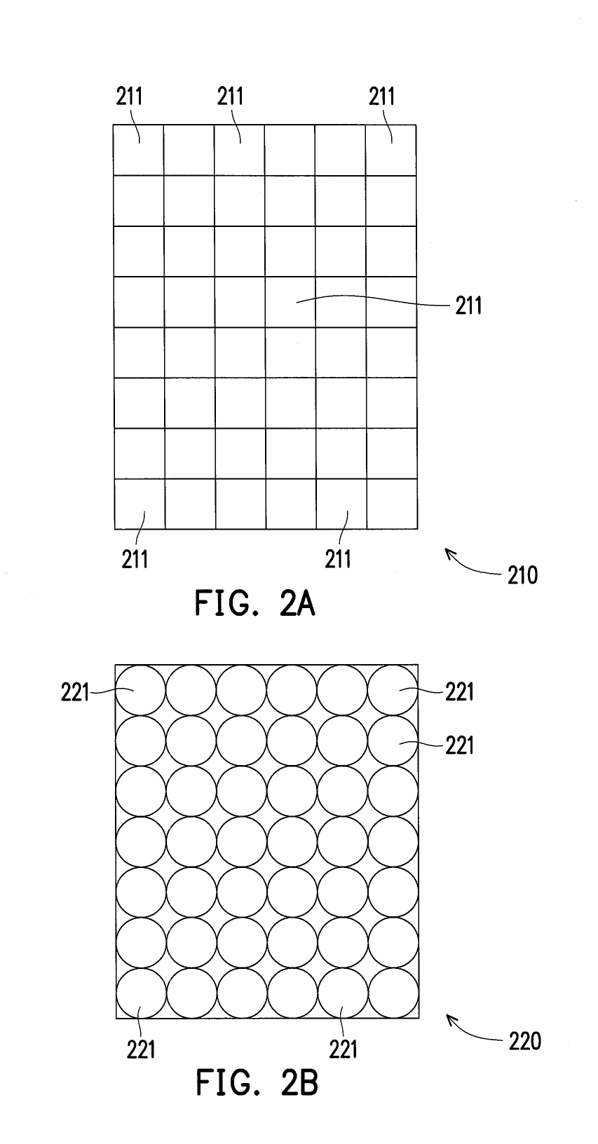

Referring to FIG. 2A-FIG. 2C for an operation detail of dividing the display image into the sub-display images, FIG. 2A-FIG. 2C are schematic diagrams illustrating implementations of dividing a plurality of sub-display images. Referring to FIG. 2A, at least one rectangle dividing regions are set, and the display image 210 is divided into a plurality of sub-display images 211 according to the dividing regions. In the present embodiment, the sub-display images 211 are arranged in an array on the display image 210, and the adjacent sub-display images 211 contact to each other without being overlapped to each other, and the adjacent sub-display images 211 are closely arranged on the display image 210.

Moreover, in the implementation of FIG. 2B, the dividing regions are round regions, and the display image 220 is divided into a plurality of sub-display images 221 according to the dividing regions. In the present embodiment, the adjacent sub-display images 221 contact to each other without being overlapped to each other. To be specific, the adjacent sub-display images 221 are arranged on the display image 210 in a circumscribing manner.

In the implementation of FIG. 2C, the dividing regions are also round regions, and the display image 230 is divided into a plurality of sub-display images 231 according to the dividing regions. Different to the implementation of FIG. 2C, the adjacent sub-display images 231 of FIG. 2C contact to each other and are partially overlapped to each other.

It should be noticed that a size of each of the dividing regions can be set according to a size of each of the sub-display regions that can be perceived by human eyes, and the shape of the dividing region is not limited, and besides the rectangles and rounds shown in FIG. 2A and FIG. 2C, the shape of the dividing region can be other regular shape or irregular shape.

For example, if the shape of each of the dividing regions is a rectangle, and the size of the dividing region is 11×11 pixels, when human eyes perceive a flickering phenomenon of the sub-display images divided according to the rectangular dividing regions, the size of the dividing region is required to be changed to 10×10 pixels, such that the human eyes cannot perceive the flickering phenomenon of the sub-display images divided according to the rectangular dividing regions.

Moreover, on the display image, the sizes of the dividing regions used for producing the sub-display images can be the same, partially same or totally different. In brief, when an edge region of the display image is divided to form the sub-display images, the used size of the dividing region can be a first size, and central region of the display image is divided to form the sub-display images, the used size of the dividing region can be a second size, where the first size can be greater than the second size.

Referring back to FIG. 1, after the step 5110 is completed, in step S120, a plurality of patterns corresponding to the sub-display images are found, where the patterns respectively correspond to a plurality of refresh frequency request values. A plurality of refresh frequency request values respectively corresponding to the sub-display images can be calculated according to a relationship between the sub-display images, the patterns and the refresh frequency request values.

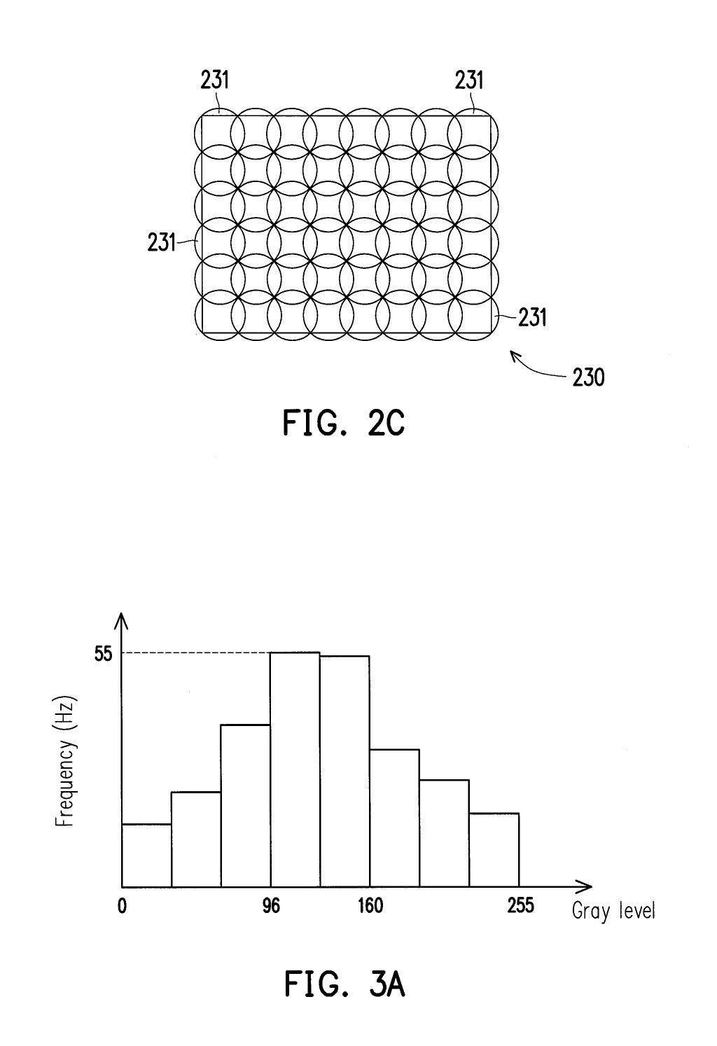

Regarding an implementation detail of the step S120, referring to FIG. 3A, FIG. 3A is a diagram illustrating a relationship between gray levels and the refresh frequency request values. The patterns corresponding to the sub-display images can be gray levels of the sub-display images. By obtaining the gray level of each of the sub-display images, and according to the corresponding relationship diagram of the gray levels and the refresh frequency request values shown in FIG. 3A, the refresh frequency request value corresponding to each of the sub-display images is obtained. As shown FIG. 3A, regarding the sub-display images with higher gray levels and lower gray levels, the required refresh frequency request values thereof are relatively low, and the sub-display images with middle gray levels require a higher refresh frequency request value. Taking the gray level of 8-bit as an example, the sub-display images with gray levels between 96 and 160 require a higher refresh frequency request value (about 55 Hz), and the sub-display images with the other gray levels require lower refresh frequency request values.

The relationship diagram of FIG. 3A can be set according to different sensitivities of human eyes for different image gray levels. The human eyes are more sensitive for the sub-display images with middle gray levels, such that a higher refresh frequency request value is required to avoid the situation that human eyes perceive the image flickering phenomenon. Comparatively, the human eyes are less sensitive for the sub-display images with higher and lower gray levels, such that a lower refresh frequency request value is required.

Moreover, regarding implementation of the step S120, referring to FIG. 3B, FIG. 3B is a schematic diagram of a plurality of setting patterns according to an embodiment of the invention. The setting patterns 321-327 respectively correspond to a plurality of different refresh frequency setting values. The setting pattern 321 is a pure-color display image, the setting pattern 322 is a transverse gradient display image, the setting pattern 323 is a dark ground horizontal stripe image, the setting pattern 324 is a bright ground horizontal stripe image, and the setting patterns 325-327 are images obtained by rotating the setting patterns 322-324 by 90 degrees.

In the setting patterns 321-327 of FIG. 3B, the sub-display images corresponding to the setting patterns 321, 322 and 323 correspond to higher refresh frequency setting values, the sub-display image corresponding to the setting pattern 325 corresponds to secondary higher refresh frequency setting value, and the sub-display images corresponding to the setting patterns 324, 326 and 327 correspond to lower refresh frequency setting values.

By comparing the setting patterns 321-327 of the sub-display images, the refresh frequency setting value corresponding to the setting pattern (one of the setting patterns 321-327) similar to the pattern of the sub-display image can be selected to serve as the refresh frequency request value.

The refresh frequency setting values corresponding to the aforementioned patterns can be set according to different sensitivities of human eyes for different display patterns, and the setting patterns shown in FIG. 3B are only examples, which are not used to limit a scope of the invention, and the user can increase or decrease the types of the setting patterns according to an actual requirement, which is not limited by the invention.

Referring back to FIG. 1, in step S130, a refresh frequency adapted to the display image is calculated according to the refresh frequency request values obtained in the step S120, where an arithmetic operation can be performed to the obtained refresh frequency request values to obtain the refresh frequency. To be specific, when the gray levels of the sub-display images are used as the patterns thereof, the corresponding higher refresh frequency request value can be selected as the refresh frequency of the display image, or an average of the refresh frequency request values can be used as the refresh frequency of the display image. Moreover, an arithmetic operation can be performed to the gray levels of all of the sub-display images to obtain a statistic gray level, for example, to calculate an average of the gray levels to serve as the statistic gray level, and then the refresh frequency request value corresponding to the average of the gray levels is found to serve as the refresh frequency of the display image.

The arithmetic operation implemented by the average calculation can also be implemented by a mode calculation.

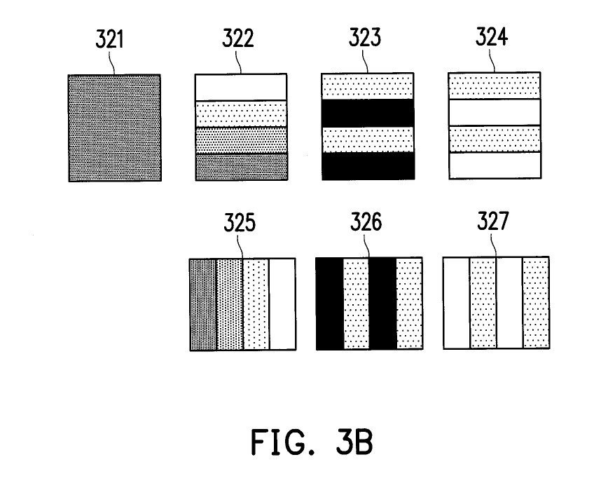

Regarding implementation details of the step S120, referring to FIG. 4A,

FIG. 4A is a schematic diagram of a calculation method of a refresh frequency of a display image according to an embodiment of the invention. The display image 400 includes a plurality of sub display image 411-4MN, where the refresh frequency request value corresponding to each of the sub-display images 411-4MN is one of the refresh frequency request values A-G. For example, the refresh frequency request values A-G are sequentially 55 Hz, 50 Hz, 45 Hz, 40 Hz, 35 Hz, 30 Hz and 25 Hz. In an embodiment of the invention, the highest one of the refresh frequency request values corresponding to the sub-display images 411-4MN can be selected as the refresh frequency of the display image 400. In the present embodiment, the refresh frequency request value A (55 Hz) is selected as the refresh frequency of the display image 400.

On the other hand, referring to FIG. 4B, FIG. 4B is a schematic diagram of a weight value distribution according to an embodiment of the invention. The weight value distribution WTB corresponds to the display image 400. A region WRG1 of the weight value distribution WTB corresponds to a display region RG1 of the display image 400. In FIG. 4B, a central display region (i.e. the display region RG1) of the display image 400 has a higher weight value (for example, 100%), and a peripheral display region (the region outside the display region RG1) has lower weight values (for example, 70%-85%).

In the present embodiment of the invention, the refresh frequency of the display image 400 can be calculated according to the refresh frequency request values and the corresponding weight values. Namely, a weight value of each of the sub-display images can be obtained according to a position of the weight value distribution WTB corresponding to a region where the sub-display image is located, and then a weight refresh frequency request value is calculated according to the corresponding refresh frequency request value and the found weight value. Then, after the weight refresh frequency request values of all of the sub-display images are calculated, a maximum one of the weight refresh frequency request values can be selected as the refresh frequency of the display image.

In the embodiment of FIG. 4A and FIG. 4B, the refresh frequency of the display image obtained according to the weight value distribution WTB is 50 Hz.

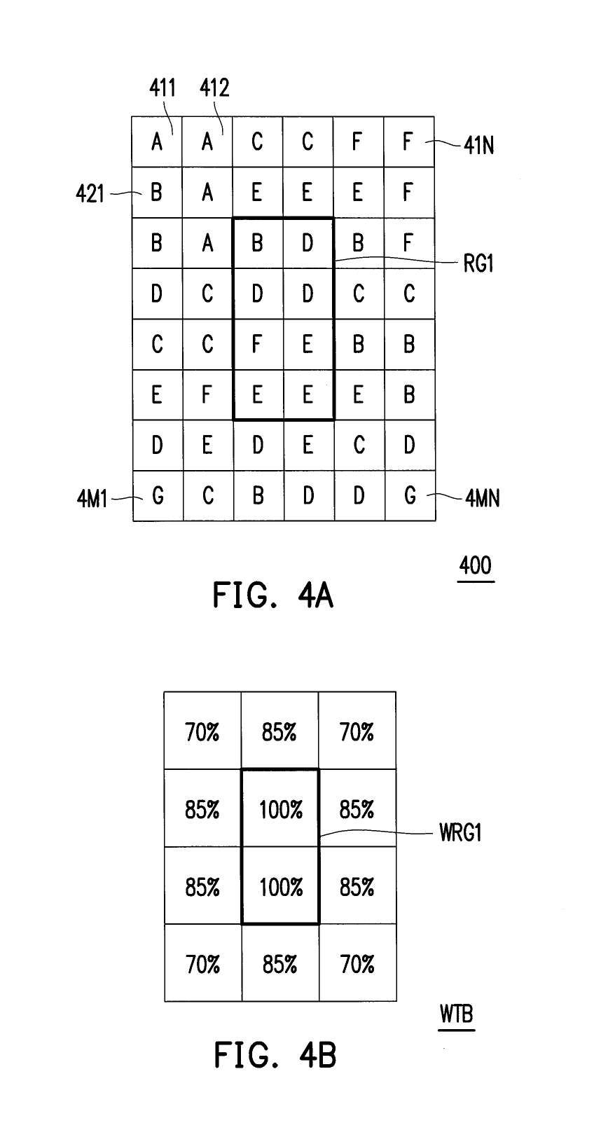

Referring to FIG. 5, FIG. 5 is a relationship diagram of refresh frequencies and backlight brightness according to an embodiment of the invention. Since when the backlight brightness is lower, a visual sensitivity of human eyes is decreased, in the present embodiment, a frequency adjustment value is obtained according to the backlight brightness of the display apparatus. Moreover, the refresh frequency is reduced according to the frequency adjustment value to generate a reduced refresh frequency.

To be specific, when the backlight brightness of the display apparatus is set to 40%, a frequency adjustment value can be obtained according to the backlight brightness of 40%, and the refresh frequency is further reduced according to the frequency adjustment value.

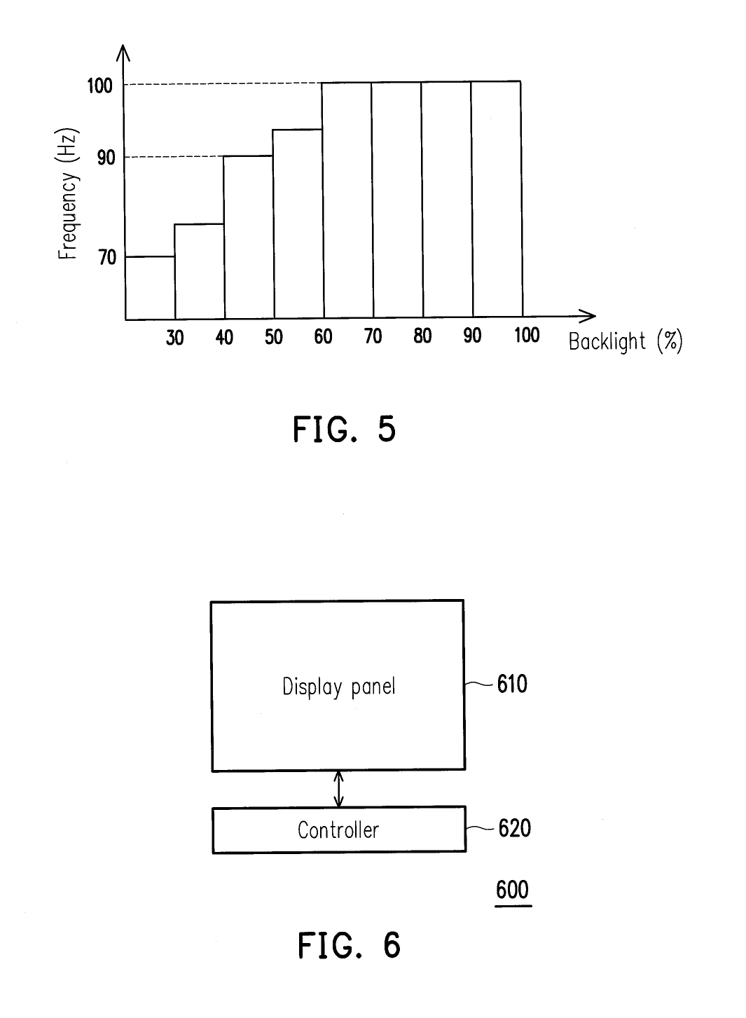

FIG. 6 is a schematic diagram of a display apparatus according to an embodiment of the invention. Referring to FIG. 6, the display apparatus 600 includes a display panel 610 and a controller 620. The display panel 610 is coupled to the controller 620. The display panel 610 generates a display image, and the controller 620 divides the display image into a plurality of sub-display images. The controller 620 calculates a plurality of refresh frequency request values respectively corresponding to the sub-display images according to a plurality of patterns respectively corresponding to the sub-display images, and the controller 620 calculates a refresh frequency of the display image according to the refresh frequency request values.

The operation details of the controller 620 have been described in detail in the aforementioned embodiments and implementations, and details thereof are repeated.

In summary, the display image is divided into a plurality of sub-display images, and the patterns of the sub-display images are analyzed to calculate a proper refresh frequency. In this way, the display apparatus can display the display image according to a proper refresh frequency, so as to achieve a purpose of saving power consumption.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A method for controlling a refresh frequency, adapted to a display apparatus, comprising:
dividing a display image of the display apparatus into a plurality of sub-display images;
calculating a plurality of refresh frequency request values respectively corresponding to the sub-display images according to a plurality of patterns respectively corresponding to the sub-display images; and
calculating a refresh frequency of the display image according to the refresh frequency request values.

2. The method for controlling the refresh frequency as claimed in claim 1, wherein the display image is a static display image.

3. The method for controlling the refresh frequency as claimed in claim 1, wherein the patterns respectively have a plurality of gray levels.

4. The method for controlling the refresh frequency as claimed in claim 3, wherein the step of respectively calculating the refresh frequency request values respectively corresponding to the sub-display images according to the patterns respectively corresponding to the sub-display images comprises:
calculating the gray levels respectively corresponding to the sub-display images, and obtaining the refresh frequency request values respectively corresponding to the sub-display images according to the gray levels; and
performing an arithmetic operation to the refresh frequency request values to obtain the refresh frequency.

5. The method for controlling the refresh frequency as claimed in claim 3, wherein the step of respectively calculating the refresh frequency request values respectively corresponding to the sub-display images according to the patterns respectively corresponding to the sub-display images comprises:
calculating the gray levels respectively corresponding to the sub-display images, and performing an arithmetic operation to the gray levels to obtain a statistic gray level; and
obtaining the refresh frequency according to the statistic gray level.

6. The method for controlling the refresh frequency as claimed in claim 1, wherein the step of respectively calculating the refresh frequency request values respectively corresponding to the sub-display images according to the patterns respectively corresponding to the sub-display images comprises:
setting a plurality of setting patterns, wherein the setting patterns respectively correspond to a plurality of refresh frequency setting values; and
comparing each of the patterns corresponding to each of the sub-display images with the setting patterns to select one of the refresh frequency setting values as the refresh frequency request value corresponding to each of the sub-display images.

7. The method for controlling the refresh frequency as claimed in claim 1, further comprising:
determining a plurality of weight values respectively corresponding to the sub-display images according to regions where the sub-display images are located in the display image; and
calculating the refresh frequency according to the refresh frequency request values and the corresponding weight values.

8. The method for controlling the refresh frequency as claimed in claim 1, wherein the step of dividing the display image of the display apparatus into a plurality of the sub-display images comprises:
setting at least one dividing region; and
dividing the display image of the display apparatus into the sub-display image according to the dividing region.

9. The method for controlling the refresh frequency as claimed in claim 8, wherein the sub-display images contact each other, and the adjacent sub-display images are not overlapped to each other or partially overlapped to each other.

10. The method for controlling the refresh frequency as claimed in claim 8, wherein a shape of the dividing region is a rectangle, a round or an irregular shape, and sizes of the dividing regions are the same, partially same or totally different.

11. The method for controlling the refresh frequency as claimed in claim 1, further comprising:
obtaining a frequency adjustment value according to a backlight brightness of the display apparatus; and
reducing the refresh frequency according to the frequency adjustment value to generate a reduced refresh frequency.

12. A display apparatus, comprising:
a display panel, generating a display image; and
a controller, coupled to the display panel, dividing the display image into a plurality of sub-display images, calculating a plurality of refresh frequency request values respectively corresponding to the sub-display images according to a plurality of patterns respectively corresponding to the sub-display images, and calculating a refresh frequency of the display image according to the refresh frequency request values.

13. The display apparatus as claimed in claim 12, wherein the display image is a static display image.

14. The display apparatus as claimed in claim 12, wherein the patterns respectively have a plurality of gray levels.

15. The display apparatus as claimed in claim 14, wherein the controller calculates the gray levels respectively corresponding to the sub-display images, obtains the refresh frequency request values respectively corresponding to the sub-display images according to the gray levels, and performs an arithmetic operation to the refresh frequency request values to obtain the refresh frequency.

16. The display apparatus as claimed in claim 14, wherein the controller calculates the gray levels respectively corresponding to the sub-display images, performs an arithmetic operation to the gray levels to obtain a statistic gray level, and obtains the refresh frequency according to the statistic gray level.

17. The display apparatus as claimed in claim 12, wherein the controller sets a plurality of setting patterns, wherein the setting patterns respectively correspond to a plurality of refresh frequency setting values, and the controller compares each of the patterns corresponding to each of the sub-display images with the setting patterns to select one of the refresh frequency setting values as the refresh frequency request value corresponding to each of the sub-display images.

18. The display apparatus as claimed in claim 12, wherein the controller determines a plurality of weight values respectively corresponding to the sub-display images according to regions where the sub-display images are located in the display image, and calculates the refresh frequency according to the refresh frequency request values and the corresponding weight values.

19. The display apparatus as claimed in claim 12, wherein the controller sets at least one dividing region, and divides the display image of the display apparatus into the sub-display image according to the at least one dividing region.

20. The display apparatus as claimed in claim 12, wherein the sub-display images contact each other, and the adjacent sub-display images are not overlapped to each other or partially overlapped to each other.

21. The display apparatus as claimed in claim 19, wherein a shape of the dividing region is a rectangle, a round or an irregular shape, and sizes of the dividing regions are the same, partially same or totally different.

22. The display apparatus as claimed in claim 12, wherein the controller obtains a frequency adjustment value according to a backlight brightness of the display apparatus, and reduces the refresh frequency according to the frequency adjustment value to generate a reduced refresh frequency.
